(19) United States
(12) Patent Application Publication
(10) Pub. No.: US 2025/0286246 A1
(43) Pub. Date: Sep. 11, 2025

(54) ELECTRODE ASSEMBLY AND METHOD FOR MANUFACTURING THE SAME AND RECHARGEABLE BATTERY INCLUDING THE SAME

(71) Applicant: SAMSUNG SDI CO., LTD., Yongin-si (KR)

(72) Inventors: Hyeokjoo KIM, Yongin-si (KR); Duckhyun KIM, Yongin-si (KR)

(21) Appl. No.: 18/748,545

(22) Filed: Jun. 20, 2024

(30) Foreign Application Priority Data
Mar. 6, 2024 (KR) 10-2024-0032188

(51) Int. Cl. H01M 50/54; H01M 4/04; H01M 50/46; H01M 50/533; H01M 50/536

(52) U.S. Cl. CPC H01M 50/54; H01M 4/0404; H01M 50/46; H01M 50/533; H01M 50/536

(57) ABSTRACT

An electrode assembly includes a plurality of first electrodes, each of the plurality of first electrodes including a first substrate coated with an electrode active material, and a first protrusion protruding from one side of the first substrate and having a first electrode tab of a first length thereon, which is partially uncoated, a plurality of second electrodes, each of the plurality of second electrodes including a second substrate coated with an electrode active material, and a second protrusion protruding from one side of the second substrate and having a second electrode tab of the first length thereon, which is partially uncoated, and a plurality of separators, each of the plurality of separators interposed between one of the plurality of first electrodes and one of the plurality of second electrodes.

### CROSS-REFERENCE TO RELATED APPLICATION

This application claims priority to and the benefit of Korean Patent Application No. 10-2024-0032188 filed at the Korean Intellectual Property Office on Mar. 6, 2024, the entire contents of which are incorporated herein by reference.

### BACKGROUND

### 1. Field

Embodiments relate to an electrode assembly, a rechargeable battery including the electrode assembly and a method for manufacturing the electrode assembly.

### 2. Description of the Related Art

Generally, unlike a primary battery, a rechargeable (or secondary) battery may be charged and discharged over and over again. Low-capacity rechargeable batteries are used in small, portable electronic devices such as mobile phones, laptop computers, and camcorders, while high-capacity batteries are widely used as a power source for driving motors in hybrid vehicles.

Representative rechargeable batteries include nickel cadmium (Ni-Cd) batteries, nickel hydrogen (Ni-MH) batteries, lithium (Li) batteries, and lithium ion (Li-ion) rechargeable batteries. Particularly, lithium-ion rechargeable batteries have an operation voltage about three times higher than nickel cadmium batteries or nickel hydrogen batteries, which are widely used as power sources for portable electronic equipment. In addition, since lithium-ion rechargeable batteries have high energy density per unit weight, lithium-ion rechargeable batteries are widely used.

Rechargeable batteries mainly use lithium-based oxide as the positive electrode active material and carbon as the negative electrode active material. Generally, lithium rechargeable batteries are categorized as either liquid electrolyte batteries or polymer electrolyte batteries, with batteries using liquid electrolytes being called lithium-ion batteries and batteries using polymer electrolytes being called lithium polymer batteries.

Rechargeable batteries are prepared by stacking a negative electrode and a positive electrode on both sides with a separator therebetween. The negative electrode and the positive electrode are prepared by cutting a reel-shaped substrate, and folding damage frequently occurs during the manufacturing process of an electrode tab.

Also, the electrode tab is typically formed through a mold notching process, which complicates the manufacturing process and increases manufacturing costs.

In addition, the connection structure between an electrode assembly and a terminal is complicated, which causes a problem in that cell capacity is reduced.

### SUMMARY

Embodiments include an electrode assembly, including a plurality of first electrodes, each of the plurality of first electrodes including a first substrate coated with an electrode active material, and a first protrusion partially uncoated and protruding from one side of the first substrate and having a first electrode tab of a first length thereon, a plurality of second electrodes, each of the plurality of second electrodes including a second substrate coated with an electrode active material, and a second protrusion partially uncoated and protruding from one side of the second substrate and having a second electrode tab of the first length thereon, and a plurality of separators, each of the plurality of separators interposed between one of the plurality of first electrodes and one of the plurality of second electrodes.

A first coating part may be attached to the first protrusion on a surface other than the first electrode tab.

A second coating part may be attached to the second protrusion on a surface other than the second electrode tab.

Each of the plurality of first electrodes may have a first incision in the first substrate exposing the second electrode tab in a stacked state.

Each of the plurality of second electrodes may have a second incision in the second substrate exposing the first electrode tab in a stacked state.

Each of the plurality of separators may have an exposed part and each of the first electrode tab and the second electrode tab may be exposed in a stacked state.

The plurality of first electrode tabs and the plurality of second electrode tabs may be fixed to each other by a conductive adhesive.

The adhesive may have a thickness ranging from 0.1 mm to 30 mm.

Embodiments include a rechargeable battery, including an electrode assembly, the electrode assembly including a plurality of first electrodes, each of the plurality of first electrodes including a first substrate coated with an electrode active material, and a first protrusion, which is partially uncoated and protruding from one side of the first substrate and having a first electrode tab of a first length thereon, a plurality of second electrodes, each of the plurality of second electrodes including a second substrate coated with an electrode active material, and a second protrusion, which is partially uncoated and protruding from one side of the second substrate and having a second electrode tab of the first length thereon, and a plurality of separators, each of the plurality of separators interposed between one of the plurality of first electrodes and one of the plurality of second electrodes, a case accommodating the electrode assembly, a cap plate coupled to an opening of the case and having a terminal hole thereon, an electrode terminal installed on the cap plate and including a first electrode terminal and a second electrode terminal, and a lead tab including a first current collecting tab connecting the electrode assembly to the first electrode terminal and a second current collecting tab connecting the electrode assembly to the second electrode terminal.

A first coating part may be attached to the first protrusion on a surface other than the first electrode tab, and a second coating part may be attached to the second protrusion on a surface other than the second electrode tab.

Each of the plurality of first electrodes may have a first incision in the first substrate exposing the second electrode tab in a stacked state, and each of the plurality of second electrodes may have a second incision in the second substrate exposing the first electrode tab in a stacked state.

Each of the plurality of separators may have an exposed part and each of the first electrode tab and the second electrode tab may be exposed in a stacked state.

The first electrode tab and the second electrode tab may be fixed to each other by a conductive adhesive.

Embodiments include a method for manufacturing an electrode assembly, the method including coating a first substrate with a first electrode active material and a second substrate with a second electrode active material, forming a first protrusion by cutting a part of one side of the first substrate using a laser, and forming a first electrode tab, which is an uncoated region, by laser etching a part of a surface of the first protrusion, forming a second protrusion by cutting a part of one side of the second substrate using a laser, and forming a second electrode tab, which is an uncoated region, by laser etching a part of a surface of the second protrusion, cutting parts of both sides of an edge of a separator using a laser to form exposed parts where the first electrode tab and the second electrode tab are respectively exposed, and stacking the first electrode and the second electrode on each side facing each other with the separator therebetween.

A first coating part may be attached to the first protrusion on a surface other than the first electrode tab, and a second coating part may be attached to the second protrusion on a surface other than the second electrode tab.

The first electrode may have a first incision exposing the second electrode tab in a stacked state, and the second electrode may have a second incision exposing the first electrode tab in a stacked state.

The separator may have an exposed part and each of the first electrode tab and the second electrode tab may be exposed in a stacked state.

The first electrode tab and the second electrode tab may be fixed to each other by a conductive adhesive.

The method may further include fixing the first electrode tab and the second electrode tab with a conductive adhesive.

A thickness of the conductive adhesive may range from 0.1 mm to 30 mm.

### BRIEF DESCRIPTION OF THE DRAWINGS

Features will become apparent to those of ordinary skill in the art by describing in detail exemplary embodiments with reference to the attached drawings, in which:

FIG. 1 is a perspective view schematically illustrating a rechargeable battery according to one or more embodiments of the present disclosure;

FIG. 2 is a cross-sectional view schematically illustrating the rechargeable battery of FIG. 1 according to one or more embodiments of the present disclosure;

FIG. 3 is a perspective view schematically illustrating an electrode assembly according to one or more embodiments of the present disclosure;

FIG. 4 is a perspective view schematically illustrating a state in which a conductive adhesive has been removed from the electrode assembly of FIG. 3 according to one or more embodiments of the present disclosure;

FIG. 5 is an exploded perspective view schematically illustrating a state in which first/second electrodes and a separator of the electrode assembly of FIG. 4 are separated according to one or more embodiments of the present disclosure;

FIG. 6 is a top plan view schematically illustrating a main part of a substrate for manufacturing a first electrode according to one or more embodiments of the present disclosure;

FIG. 7 is a top plan view schematically illustrating a state in which the first electrode is manufactured by cutting the substrate of FIG. 6 according to one or more embodiments of the present disclosure;

FIG. 8 is a top plan view schematically illustrating a main part of a substrate for manufacturing a second electrode according to one or more embodiments of the present disclosure;

FIG. 9 is a top plan view schematically illustrating a state in which the second electrode is manufactured by cutting the substrate of FIG. 8 according to one or more embodiments of the present disclosure;

FIG. 10 is a top plan view schematically illustrating a separator according to one or more embodiments of the present disclosure; and

FIG. 11 is a flowchart schematically illustrating a method for manufacturing an electrode assembly according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

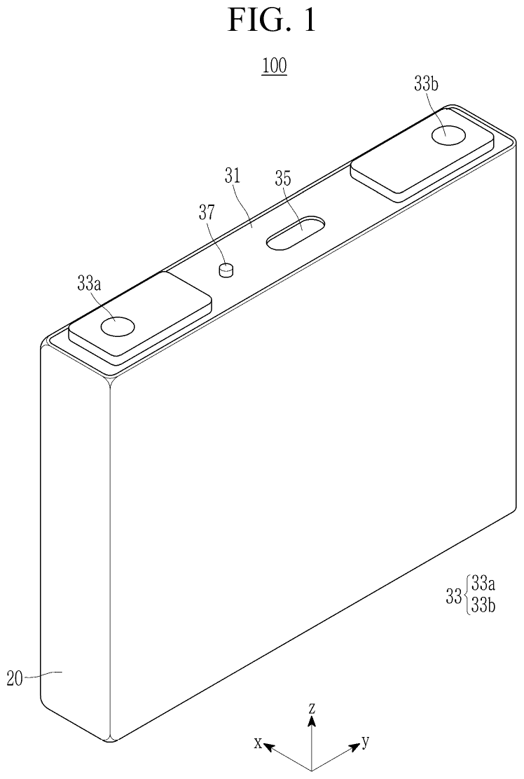

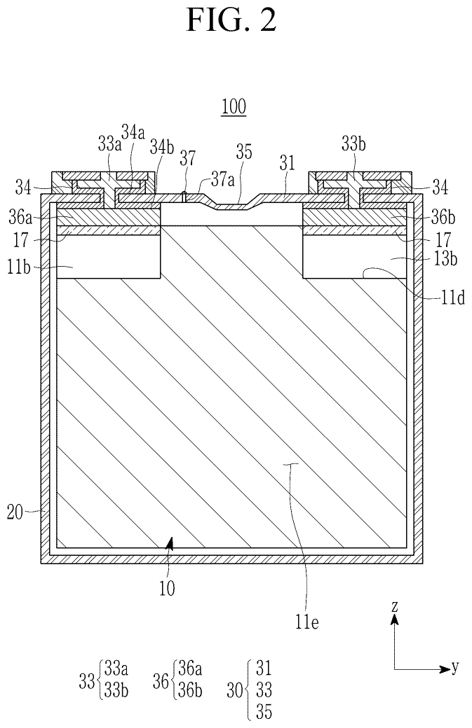

FIG. 1 is a perspective view schematically illustrating a rechargeable battery according to one or more embodiments of the present disclosure, and FIG. 2 is a cross-sectional view schematically illustrating the rechargeable battery of FIG. 1 according to one or more embodiments of the present disclosure.

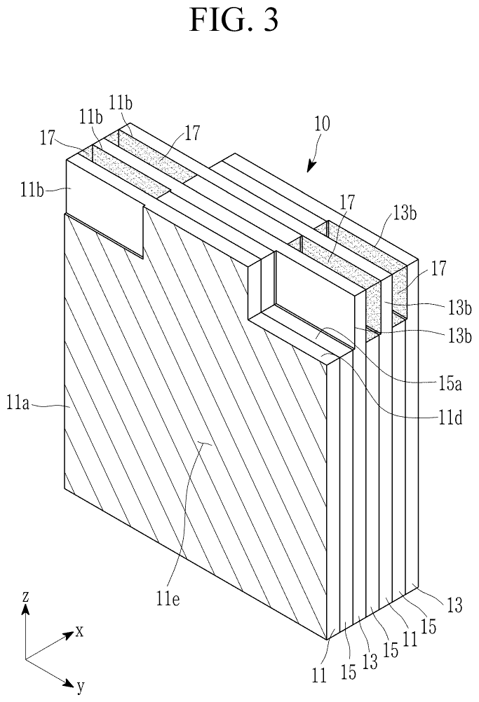

As shown in FIGS. 1 and 2, a rechargeable battery 100 according to an embodiment of the present disclosure includes a separator 15 (see FIG. 3), an electrode assembly 10 including first electrodes 11 and second electrodes 13 disposed on both sides of the separator 15, a case 20 accommodating the electrode assembly 10, a cap plate 31 coupled to an opening of the case 20 and having a terminal hole, an electrode terminal 33 installed on the cap plate 31 and including a first electrode terminal 33a and a second electrode terminal 33b, and a lead tab 36 including a first current collecting tab 36a connecting the electrode assembly 10 to the first electrode terminal 33a and a second current collecting tab 36b connecting the electrode assembly 10 to the second electrode terminal 33b.

The rechargeable battery 100 according to the present embodiment is described as an example of a lithium-ion rechargeable battery having a square shape. However, the present disclosure is not limited to the shape or battery type, and the present disclosure may be applied to batteries having a different shape and/or a different battery type, for example, lithium polymer batteries.

In addition, the first electrode 11 may be configured as a negative electrode and the second electrode 13 may be configured as a positive electrode, and conversely, the first electrode 11 may be configured as a positive electrode and the second electrode 13 may be configured as a negative electrode. However, in the present disclosure, to facilitate understanding and ease of description, the first electrode 11 and the second electrode 13 will be used instead of the negative electrode and positive electrode.

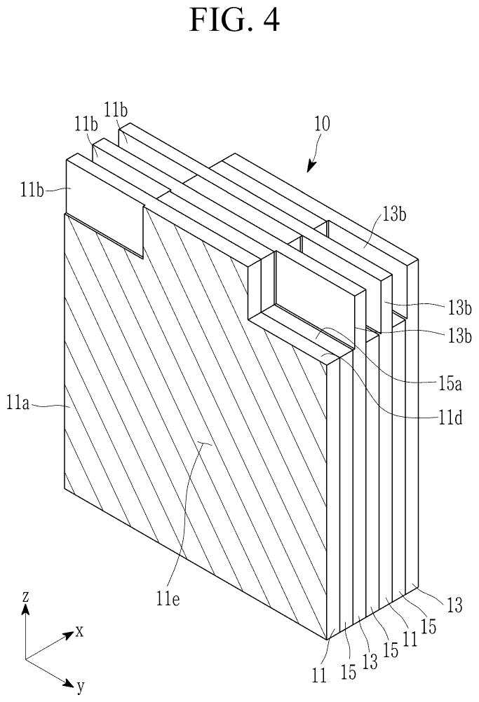

FIG. 3 is a perspective view schematically illustrating an electrode assembly according to one or more embodiments of the present disclosure, and FIG. 4 is a perspective view schematically illustrating a state in which a conductive adhesive has been removed from the electrode assembly of FIG. 3 according to one or more embodiments of the present disclosure.

As shown in FIGS. 3 and 4, the electrode assembly 10 may be stacked with the first electrode 11 and the second electrode 13 disposed on both sides of a separator 15, which is an insulator. The first electrode 11 and the second electrode 13 may have the same or a similar shape and be stacked in an inverted state on both sides with the separator 15 therebetween. The first electrodes 11 and the second electrodes 13 will be described in detail below.

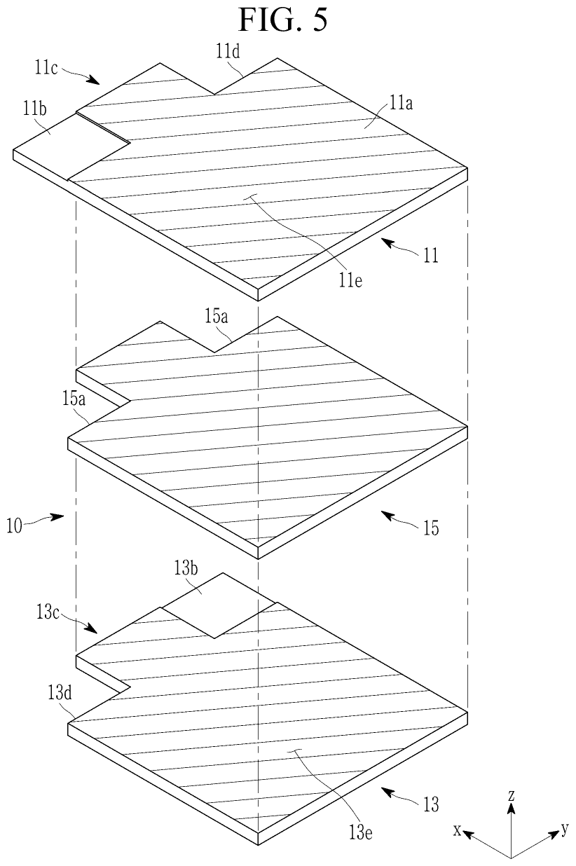

The first electrode 11 may include a first substrate 11a coated with an electrode active material, and a first protrusion 11c (see FIG. 5) protruding from one side of the first substrate 11a and having a first electrode tab 11b of a first length thereon which is partially uncoated.

The first substrate 11a may have a substantially rectangular or square polygonal shape by cutting a reel-shaped substrate using, for example, laser irradiation.

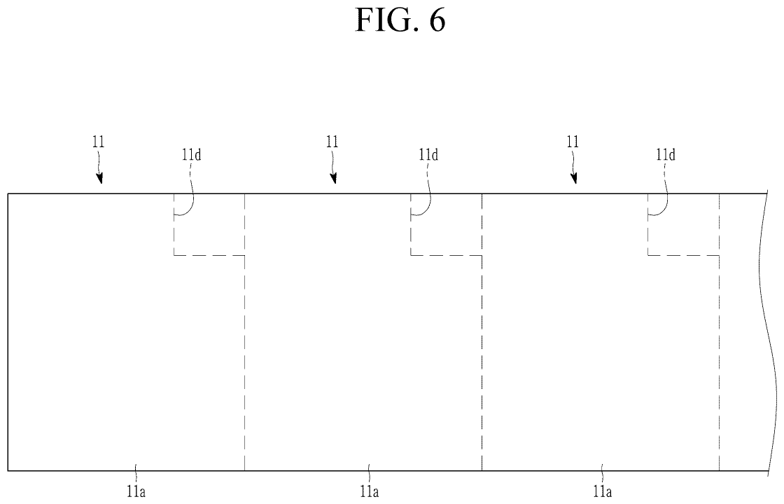

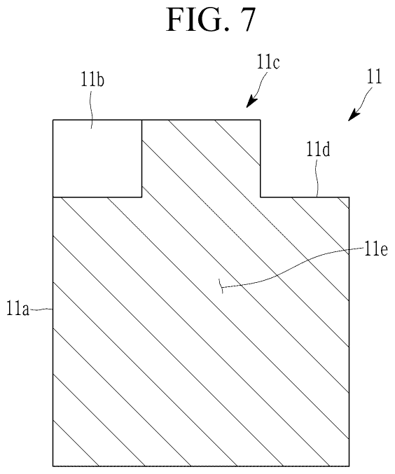

FIG. 6 is a top plan view schematically illustrating a main part of a substrate for manufacturing a first electrode according to one or more embodiments of the present disclosure, and FIG. 7 is a top plan view schematically illustrating a state in which the first electrode is manufactured by cutting the substrate of FIG. 6.

As shown in FIGS. 6 and 7, the substrate for manufacturing the first substrate 11a may be supplied without electrode tabs formed during the supply process, and may be cut into a polygonal first substrate 11a shape by, for example, irradiation with a laser or ultrasonic waves.

A first protrusion 11c for forming the first electrode tab 11b may be on one edge (e.g., the left side edge in FIG. 7) of the first substrate 11a.

The first protrusion 11c may be made by making a first incision 11d on a part of one edge of the first substrate 11a by, for example, irradiating with a laser or ultrasonic waves. The first substrate may have a polygonal shape.

That is, the first protrusion 11c refers to the remaining part excluding the first incision 11d on one edge of the first substrate 11a.

The first electrode tab 11b may be on a part of the first protrusion 11c.

The first electrode tab 11b may be formed by removing the electrode active material from a part of a surface of the first protrusion 11c by, for example, laser etching.

That is, the first electrode tab 11b may be an uncoated region from which a part of the surface of the first protrusion 11c has been removed by, e.g., laser etching.

Accordingly, in the stacked state of the electrode assembly 10, the first current collecting tab 36a may be welded to the plurality of first electrode tabs 11b and may be electrically connected to the first electrode terminal 33a.

Meanwhile, a first coating part 11e may be attached to the surface of the first electrode 11.

The first coating part 11e may be attached to an outer surface of the first electrode 11 excluding the part where the first electrode tab 11b is on the side surface of the first electrode 11, such that the separator 15 and the first electrode 11 are in surface contact with each other in an insulating state.

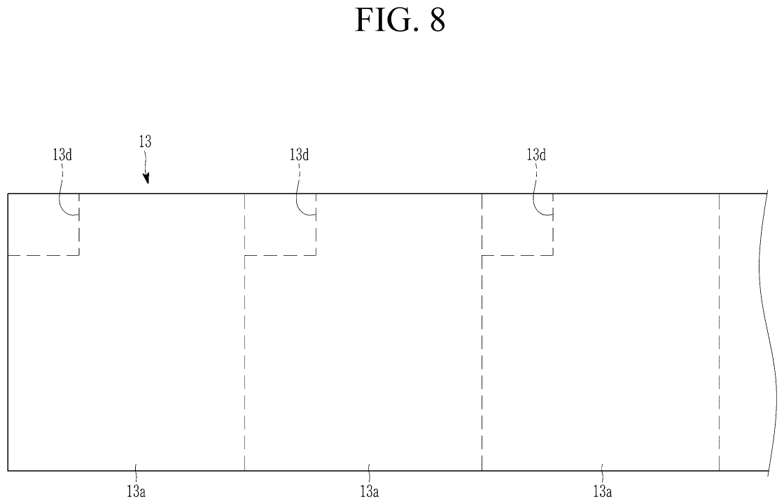

The second electrode 13 may include a second substrate 13a (see FIG. 8) coated with an electrode active material, and the first protrusion 11c (see FIG. 5) protruding from one side of a second substrate 13a and having a partially uncoated second electrode tab 13b of the first length thereon.

The second substrate 13a may have a substantially rectangular or square polygonal shape by cutting a reel-shaped substrate using, for example, laser irradiation.

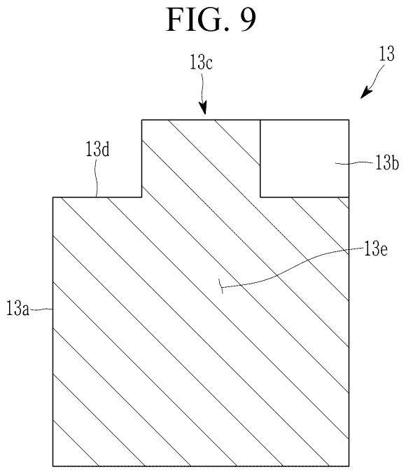

FIG. 8 is a top plan view schematically illustrating a main part of a substrate for manufacturing a second electrode according to one or more embodiments of the present disclosure, and FIG. 9 is a top plan view schematically illustrating a state in which the second electrode is manufactured by, for example, cutting the substrate of FIG. 8.

As shown in FIGS. 8 and 9, the substrate for manufacturing the second substrate 13a may be supplied without electrode tabs formed during the supply process, and may be cut into a polygonal second substrate 13a shape by, for example, irradiation with a laser or ultrasonic waves.

A second protrusion 13c for forming the second electrode tab 13b may be on one edge of the second substrate 13a (for example, the right edge in FIG. 9.

The second protrusion 13c may be formed by making a second incision 13d on a part of one edge of the polygonal second substrate 13a by, for example, irradiation with a laser or ultrasonic waves.

That is, the second protrusion 13c refers to the remaining part excluding the second incision 13d on one edge of the second substrate 13a.

The second electrode tab 13b may be on a part of the second protrusion 13c.

The second electrode tab 13b may be formed by removing the electrode active material from a part of a surface of the second protrusion 13c by, e.g., laser etching.

That is, the second electrode tab 13b may be formed by an uncoated region from which a part of the surface of the second protrusion 13c has been removed by laser etching.

Accordingly, in the stacked state of the electrode assembly 10, the second current collecting tab 36b may be welded to the plurality of second electrode tabs 13b and may be electrically connected to the second electrode terminal 33b.

A second coating part 13e may be attached to the surface of the second electrode 13.

The second coating part 13e may be attached to an outer surface of the second electrode 13 excluding the second electrode tab 13b may be on the side surface of the second electrode 13, such that the separator 15 and the second electrode 13 are in surface contact with each other in an insulating state.

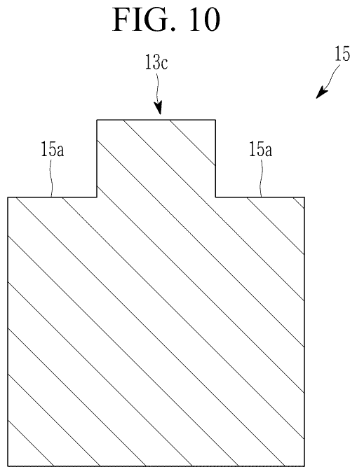

FIG. 10 is a top plan view schematically illustrating a separator according to one or more embodiments of the present disclosure.

As shown in FIG. 10, the separator 15 may be inserted between the plurality of first electrodes 11 and the plurality of second electrodes 13, and an exposed part 15a may be at the edge.

In the stacked state, the exposed part 15a may be on the edge of the separator 15 at a position corresponding to the first incision 11d of the first electrode 11 and the second incision 13d of the second electrode 13.

The exposed parts 15a may be on both sides of the edge of the separator 15 using, for example, laser irradiation.

If the plurality of first electrodes 11 and the plurality of second electrodes 13 are stacked with the separator 15 therebetween, each of the plurality of first electrode tabs 11b and the plurality of second electrode tabs 13b may be electrically connected to each other by a conductive adhesive 17 (see FIG. 3).

The conductive adhesive 17 may be inserted into the respective spaces of the first electrode tabs 11b and the second electrode tabs 13b that are spaced apart from each other in the stacked state, thereby electrically and reliably connecting the first electrode tabs 11b and the second electrode tabs 13b to each other.

The conductive adhesive 17 may have a sufficient coating thickness to stably connect the first electrode tabs 11b and the second electrode tabs 13b by being inserted into the respective spaces of the first electrode tabs 11b and the second electrode tabs 13b that are spaced apart from each other, and the conductive adhesive 17 may be coated on the surface of each of the first electrode tabs 11b and the second electrode tabs 13b in a thickness range of 0.1 mm to 30 mm in the present embodiment.

The conductive adhesive 17 provides adherence and conductivity between electrodes with metallic material, and may include a polymer and a conductive metal.

Polymers may include elastomers such as butyl rubber, isoprene rubber, and chloroprene rubber. In addition, the polymer may include ethylene-vinyl acetate copolymer, ethylene-acrylic acid copolymer, ethylene-acrylic acid ester copolymer, acrylic resin, or the like, which are obtained using monomers with few carboxyl group residues.

In some embodiments, the polymer may preferably be an acrylic resin that has few ionic impurities, has high heat resistance, and can easily secure connection reliability using a conductive adhesive.

The conductive metal may be selected from gold, silver, silver chloride, platinum, copper, tin, iron titanium, nickel, palladium, aluminum, tungsten, molybdenum, ruthenium, chromium, indium solder and carbon, or a composite thereof.

Additionally, the conductive metal may include one-dimensional or two-dimensional structures such as carbon nanotubes, graphene, and MXene.

Meanwhile, the case 20 may be made of a substantially rectangular parallelepiped, and an opening may be on one surface.

The cap assembly 30 may include the cap plate 31 having a substantially rectangular plane with long and short sides covering the opening in the case 20, the electrode terminal 33 including the first electrode terminal 33a protruding outwardly from the cap plate 31 and electrically connected to the first electrode 11, and the second electrode terminal 33b protruding outwardly from the cap plate 31 and electrically connected to the second electrode 13, and a vent plate 35 notched to fracture in response to a predetermined internal pressure.

Reference number 34 (see FIG. 2) refers to the insulating member.

The cap plate 31 may be made of a thin plate and may be coupled to the opening of the case 20 to seal the opening.

The cap plate 31 blocks the inside of the sealed case 20 from the outside. Additionally, the cap plate 31 may connect the inside and the outside to each other. For example, the cap plate 31 may have an electrolyte injection hole 37a through which electrolyte is injected into the sealed case 20.

The electrolyte injection hole 37a may be sealed by a sealing plug 37 after electrolyte injection.

The terminal 33 including the first electrode terminals 33a and the second electrode terminals 33b penetrates the cap plate 31, and an insulating member 34 is between the cap plate 31 and the terminal 33 to enable insulation between the cap plate 31 and the terminal 33.

The terminal 33 may have a cylindrical shape coupled to the terminal plate by, e.g., a rivet. The terminal 33 is not necessarily limited to a cylindrical shape and may instead have a flat shape.

The insulating member 34 may include an upper insulating member 34a disposed on an upper part of the cap plate 31 and a lower insulating member 34b disposed on a lower part of the cap plate 31.

The upper insulating member 34a may be installed to enable insulation and sealing between the cap plate 31 and the first/second terminals 33a and 33b.

The lower insulating member 34b may serve as an insulator to prevent current from flowing through the cap plate 31 and the electrode assembly 10 so that the opposing surface corresponding to the lower part of the cap plate 31 is in close contact with the lower part of the cap plate 31. The lower insulating member 34b may also be made of an elastic material capable of absorbing external impact.

The lower insulating member 34b may serve to insulate the cap plate 31 and the lead tab 36, while also allowing the lead tab 36 to be stably fixed within the case.

The lead tab 36 may include a first current collecting tab 36a that connects the electrode assembly 10 to the first electrode terminal 33a, and a second current collecting tab 36b that connects the electrode assembly 10 to the second electrode terminal 33b.

One side of the first current collecting tab 36a may be electrically welded to the surface of the plurality of first electrode tabs 11b electrically connected by the conductive adhesive 17, and the other side may be electrically connected to the first electrode terminal 33a.

One side of the second current collecting tab 36b may be electrically welded to the surface of the plurality of first electrode tabs 11b electrically connected by the conductive adhesive 17, and the other side may be electrically connected to the first electrode terminal 33a.

Each of the first current collecting tabs 11b and the second current collecting tabs 13b may have a plate shape, and may electrically connect the electrode assembly 10 to the first electrode terminals 33a and the second electrode terminals 33b.

As such, each of the first current collecting tabs 36a and the second current collecting tabs 36b may have a plate shape, making it possible to minimize the distance between the electrode assembly 10 and the cap plate 31, thereby optimizing the internal space of the cell and increasing the capacity of the battery.

As described above, according to the present embodiment, by eliminating a mold notching process for forming an electrode tab on a conventional substrate and forming an electrode tab by a process of forming an uncoated region by laser etching on a part of the substrate, it is possible to reduce the cost of the manufacturing process of the electrode tab and improve the manufacturing quality of the electrode tab.

In addition, it is possible to optimize the internal space by minimizing the space between the cap plate and the electrode assembly, thereby increasing battery capacity.

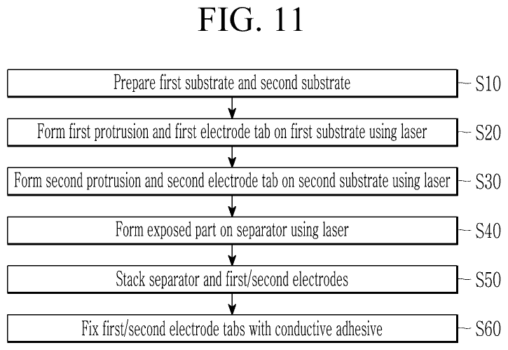

FIG. 11 is a flowchart schematically illustrating a method for manufacturing an electrode assembly according to one or more embodiments of the present disclosure. The same reference numbers as in FIGS. 1 to 10 refer to the same or similar members with the same or similar functions. Hereinafter, the same reference number refers to the same or a similar member with the same or a similar function and detailed descriptions of the same reference numbers will be omitted.

Initially, the first substrate 11a and the second substrate 13a may be prepared in step S10.

In step S10, the first substrate 11a for manufacturing the electrode assembly 10 may be prepared by cutting the reel-shaped substrate.

That is, in step S10 the first substrate 11a, which may have a reel-shape, may be cut into a polygonal shape such as a rectangle or square for manufacturing the electrode assembly 10, and the first substrate 11a may be cut by, for example, irradiation from a laser or ultrasonic waves.

Next, in step S10, a part of one side of the first substrate 11a may be cut by, for example, using a laser to form a first protrusion 11c, and a part of the surface of the first protrusion 11c may be laser etched to form a first electrode tab 11b, which may be plain, in step S20.

In step S20, a part of one edge of the first substrate 11a may be cut using a laser or ultrasonic waves to form a polygonal first protrusion 11c.

That is, since a part of one edge of the first substrate 11a is formed with the first incision 11d cut by a laser, the first protrusion 11c may be on a part where the first incision 11d is not on one side of the first substrate 11a.

The first electrode tab 11b, which is an uncoated region, may be on a part of the first protrusion 11c.

That is, a part of the surface of the first protrusion 11c may be formed as an uncoated region in which the electrode active material is removed by laser etching, thereby forming the first electrode tab 11b.

Next, in step S20, a part of one side of the second substrate 13a may be cut using, e.g., a laser or ultrasonic waves to form a second protrusion 13c, and in step S30, a part of the surface of the second protrusion 13c may be laser etched to form a second electrode tab 13b, which is an uncoated region.

In step S30, a part of one edge of the second substrate 13a may be cut using a laser to form a polygonal second protrusion 13c.

That is, the second incision 13d is made on a part of a one edge of the second substrate 13a is incised by the laser, such that the second protrusion 13c may be on a portion where the second incision 13d is not made on one side of the second substrate 13a.

The second electrode tab 13b, which is an uncoated region, may be on a part of the second protrusion 13c.

That is, a part of the surface of the second protrusion 13c may be an uncoated region in which the electrode active material may be removed by, e.g., laser etching, thereby forming the second electrode tab 13b.

Next, in step S40, a part of both sides of the edge of the separator 15 may be cut using, e.g., a laser to form the exposed parts 15a where the first electrode tabs 11b and the second electrode tabs 13b are respectively exposed.

In step S40, both sides of one edge of the separator 15 may be cut, e.g., using a laser, and a part of the separator 15 may be cut into a size corresponding to the shape of the first electrode tabs 11b and the second electrode tabs 13b.

That is, polygonal exposed parts 15a cut by, e.g., a laser at both corners of one side of the separator 15.

Next, the separator 15 and the first substrate 11a and the second substrate 13a, both of which act as electrodes when coated and stacked in the electrode assembly 10, step S50.

In step S50, the first substrate 11a and the second substrate 13a may be stacked at positions facing each other with the separator 15 therebetween.

Therefore, if the first electrode 11 and the second electrode 13 are stacked with the separator 15 therebetween, the first electrode tab 11b and the second electrode tab 13b may be exposed to the outside through the exposed part 15a of the separator 15.

Next, the plurality of first electrode tabs 11b and the plurality of second electrode tabs 13b with the conductive adhesive 17 may be fixed in step S60.

In step S60, if each of the plurality of first electrode tabs 11b and the plurality of second electrode tabs 13b are stacked, the plurality of first electrode tabs 11b and the second electrode tabs 13b may be attached to electrically connect to each other using the conductive adhesive 17.

The conductive adhesive 17 may be inserted into the space between the plurality of first electrode tabs 11b and the space between the plurality of second electrode tabs 13b, respectively, and may be attached to electrically connect the electrode tabs to each other.

The conductive adhesive 17 may be inserted into the space between the first electrode tabs 11b and the second electrode tabs 13b that are spaced apart from each other in the stacked state, thereby fixing the first electrode tabs 11b and the second electrode tabs 13b in electrical connection.

The conductive adhesive 17 may have a sufficient coating thickness to stably connect the first electrode tabs 11b and the second electrode tabs 13b by being inserted into the space between the first electrode tabs 11b and the second electrode tabs 13b that are spaced apart from each other, and the conductive adhesive 17 may be coated on the surfaces of the first electrode tabs 11b and the second electrode tabs 13b in a thickness range of 0.1 mm to 30 mm in the present embodiment.

One or more embodiments of the present disclosure seek to provide an electrode assembly that does not cause damage to an electrode tab during a manufacturing process of the electrode assembly and is capable of reducing manufacturing costs and increasing cell capacity, a method for manufacturing the same, and a rechargeable battery including the same.

According to one or more embodiments of the present disclosure, by eliminating a mold notching process for forming an electrode tab on a conventional substrate and forming an electrode tab by a process of forming an uncoated region by laser etching on a part of the substrate, it is possible to reduce the cost of the manufacturing process of the electrode tab and improve the manufacturing quality of the electrode tab.

According to one or more embodiments of the present disclosure, it is possible to optimize the internal space by minimizing the space between the cap plate and the electrode assembly, thereby increasing battery capacity.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

10 . . . Electrode assembly 11 . . . First electrode
11a . . . First substrate 11b . . . First electrode tab
11c . . . First protrusion 11d . . . First incision
11e . . . First coating part 13 . . . Second electrode
13a . . . Second substrate 13b . . . Second electrode tab
13c . . . Second protrusion 13d . . . Second incision
13e . . . Second coating part 15 . . . Separator
15a . . . Exposed part 20 . . . Case
30 . . . Cap assembly 31 . . . Cap plate
33 . . . Terminal 33a . . . First electrode terminal
33b . . . Second electrode terminal 34 . . . Insulating member
35 . . . Bent plate 36 . . . Lead tab
36a . . . First current collecting tab 36b . . . Second current collecting tab
37 . . . Sealing plug 37a . . . Electrolyte injection hole

What is claimed is:

1. An electrode assembly, comprising:
a plurality of first electrodes, each of the plurality of first electrodes including a first substrate coated with an electrode active material, and a first protrusion, partially uncoated and protruding from one side of the first substrate and having a first electrode tab of a first length thereon;
a plurality of second electrodes, each of the plurality of second electrodes including a second substrate coated with an electrode active material, and a second protrusion, partially uncoated and protruding from one side of the second substrate and having a second electrode tab of the first length thereon; and
a plurality of separators, each of the plurality of separators interposed between one of the plurality of first electrodes and one of the plurality of second electrodes.

2. The electrode assembly as claimed in claim 1, wherein a first coating part is attached to the first protrusion on a surface other than the first electrode tab.

3. The electrode assembly as claimed in claim 2, wherein a second coating part is attached to the second protrusion on a surface other than the second electrode tab.

4. The electrode assembly as claimed in claim 1, wherein each of the plurality of first electrodes has a first incision in the first substrate exposing the second electrode tab in a stacked state.

5. The electrode assembly as claimed in claim 4, wherein each of the plurality of second electrodes has a second incision in the second substrate exposing the first electrode tab in a stacked state.

6. The electrode assembly as claimed in claim 5, wherein each of the plurality of separators has an exposed part and each of the first electrode tab and the second electrode tab is exposed in the stacked state.

7. The electrode assembly as claimed in claim 6, wherein the plurality of first electrode tabs and the plurality of second electrode tabs are fixed to each other by a conductive adhesive.

8. The electrode assembly as claimed in claim 7, wherein the adhesive has a thickness ranging from 0.1 mm to 30 mm.

9. A rechargeable battery, comprising:
an electrode assembly, including:
a plurality of first electrodes, each of the plurality of first electrodes including a first substrate coated with an electrode active material, and a first protrusion, which is partially uncoated and protruding from one side of the first substrate and having a first electrode tab of a first length thereon;
a plurality of second electrodes, each of the plurality of second electrodes including a second substrate coated with an electrode active material, and a second protrusion, which is partially uncoated and protruding from one side of the second substrate and having a second electrode tab of the first length thereon; and
a plurality of separators, each of the plurality of separators interposed between one of the plurality of first electrodes and one of the plurality of second electrodes;
a case accommodating the electrode assembly;
a cap plate coupled to an opening of the case and having a terminal hole thereon;
an electrode terminal installed on the cap plate and including a first electrode terminal and a second electrode terminal; and
a lead tab including a first current collecting tab connecting the electrode assembly to the first electrode terminal and a second current collecting tab connecting the electrode assembly to the second electrode terminal.

10. The rechargeable battery as claimed in claim 9, wherein a first coating part is attached to the first protrusion on a surface other than the first electrode tab, and wherein a second coating part is attached to the second protrusion on a surface other than the second electrode tab.

11. The rechargeable battery as claimed in claim 9, wherein each of the plurality of first electrodes has a first incision in the first substrate exposing the second electrode tab in a stacked state, and wherein each of the plurality of second electrodes has a second incision in the second substrate exposing the first electrode tab in a stacked state.

12. The rechargeable battery as claimed in claim 9, wherein each of the plurality of separators has an exposed part and each of the first electrode tab and the second electrode tab is exposed in a stacked state.

13. The rechargeable battery as claimed in claim 9, wherein the plurality of first electrode tabs and the plurality of second electrode tabs are fixed to each other by a conductive adhesive.

14. A method for manufacturing an electrode assembly, the method comprising:
coating a first substrate with a first electrode active material and a second substrate with a second electrode active material;
forming a first protrusion by cutting a part of one side of the first substrate using a laser, and forming a first electrode tab, which is an uncoated region, by laser etching a part of a surface of the first protrusion;
forming a second protrusion by cutting a part of one side of the second substrate using a laser, and forming a second electrode tab, which is an uncoated region, by laser etching a part of a surface of the second protrusion;
cutting parts of both sides of an edge of a separator using a laser to expose parts where the first electrode tab and the second electrode tab are respectively exposed; and
stacking the first electrode and the second electrode on each side facing each other with the separator therebetween.

15. The method for manufacturing the electrode assembly as claimed in claim 14, wherein a first coating part is attached to the first protrusion on a surface other than the first electrode tab, and wherein a second coating part is attached to the second protrusion on a surface other than the second electrode tab.

16. The method for manufacturing the electrode assembly as claimed in claim 14, wherein the first electrode has a first incision exposing the second electrode tab in a stacked state, and wherein the second electrode has a second incision exposing the first electrode tab in a stacked state.

17. The method for manufacturing the electrode assembly as claimed in claim 14, wherein the separator has an exposed part and each of the first electrode tab and the second electrode tab is exposed in a stacked state.

18. The method for manufacturing the electrode assembly as claimed in claim 14, wherein the first electrode tab and the second electrode tab are fixed to each other by a conductive adhesive.

19. The method for manufacturing the electrode assembly as claimed in claim 14, further comprising:
fixing the first electrode tab and the second electrode tab with a conductive adhesive.

20. The method for manufacturing the electrode assembly as claimed in claim 19, wherein a thickness of the conductive adhesive ranges from 0.1 mm to 30 mm.
